(19) United States
(12) Patent Application Publication
(10) Pub. No.: US 2010/0271546 A1
(43) Pub. Date: Oct. 28, 2010

(54) Flat High Panoramic Display

(76) Inventor: Michael Stalaw, Herzliya (IL)

Correspondence Address: Eli Weiss, Esq.;Oakwood Law Group, LLP, 14 Bond Street -- SUITE 386, Great Neck, NY, 11021, US

(21) Appl. No.: 12/753,868

(22) Filed: Apr. 3, 2010

(30) Foreign Application Priority Data
Apr. 23, 2009 (IL) 198370

(51) Int. Cl. G09G 5/00; H04N 7/00

(52) U.S. Cl. 348/468; 345/1.3; 348/E07.001

(57) ABSTRACT

Apparatus and method for showing images and text separately and simultaneously on a common screen having a first display for showing TV images and a second display for showing text where the first and second displays are located adjacent to each other. The first display is a flat high resolution LCD or plasma TV showing images which are free of interwoven text, and the second display which shows only the titration text of the actors talking in the first display.

### REFERENCE TO RELATED APPLICATIONS

This patent application claims the benefit of Israel Patent Application No. 198370, filed on Apr. 23, 2009 the disclosure of which is hereby incorporated by reference in its entirety.

### BACKGROUND OF THE INVENTION

1. Field of the Invention

The present invention relates generally to an apparatus and method of showing images and text separately and simultaneously on a common screen. The first display is a flat high resolution LCD or plasma TV showing images which are free of interwoven text, and the second display is only text associated with the TV images being shown on the first display. More specifically the display consists of a first relatively large TV display that has high resolution and is used for displaying high quality images with a smaller display such as a low resolution, low cost TV or an array of LED's which is used for displaying only text where, in one embodiment the text displayed can be a translation in one language of the audio portion of a person on the first TV display speaking in another language or, in another embodiment the display can be the text being spoken by a person on the first TV display where the first TV is being played with its audio muted.

2. Description of Related Art

Methods and systems for providing closed captions for live TV programs is known in the prior art. More specifically, by way of example, U.S. Pat. No. 5,424,785 to Orphan discloses a system for encoding, storing, and displaying captions which includes a modem for transmitting a signal including one or more closed captions generated in real time, a videotape player for playing a videotape of a television program including both a video signal and a time code signal corresponding to a time position of the video tape, an encoder for receiving the video signal and a caption input and integrating the video signal and the caption input into one integrated signal for transmission, and a computer that receives captions from the modem and a time code output from the video tape player. The computer transmits the received captions to an encoder and simultaneously generates data records storing the received captions with a time code stamp corresponding to the time code signal input when the caption was received. When a playback of the captioned television program is desired, the computer retrieves the stored caption data record and synchronizes the time code stamp of each caption in the data record with the received time code output.

U.S. Pat. No. 6,820,055 to Saindon, et al. discloses receiving live speech, converting the speech to text, and transferring the text to a user. As desired, the speech or text can be translated into one or more different languages. Systems and methods for real-time conversion and transmission of speech and text are provided. The invention further provides a means of displaying, accumulating, and manipulating transmitted text within a distinct viewing field on a receiving device such as a computer, and a means of manipulating of text.

U.S. Pat. No. 5,648,789 to Beadles, et al. discloses apparatus for providing closed captioning at a performance which includes encoding a signal representing the written equivalent of spoken dialogue. The signal is synchronized with the spoken dialog and transmitted to wearable glasses of a person watching the performance. The glasses include receiving and decoding circuits and means for projecting a display image into the field of view of the person watching the performance representing at least one line of captioning.

U.S. Pat. No. 4,859,994 to Zola, et al. discloses apparatus for displaying movie subtitles with a liquid crystal display capable of forming alphanumeric images in polarized light on a cross-polarized light background. A decoder, a microprocessor and a driver are used to transfer coded information on standard movie film into appropriate subtitles which are then formed on the liquid crystal display. A polarizing material is provided to selective viewers to enable the viewers to distinguish the alphanumeric subtitles from the liquid crystal display background. This polarizing material is provided in the form of glasses which can be cross-polarized to either the alphanumeric images or to the background thereby either providing darkened letters on a light background or light letters on a darkened background.

U.S. Pat. No. 5,109,279 to Ando discloses a television receiver with a teletext receiving function, which enables both a teletext picture and a television picture to be viewed at the same time by superposing them on each other.

U.S. Pat. No. 5,537,157 to Orr, et al discloses a method of providing closed captioned data to a television viewer which includes: detecting closed captioned data signals transmitted in conjunction with a television signal; decoding the data signals to caption display signals; and displaying the caption display signals on an auxiliary screen separate from a screen displaying the television signals. As stated therein, this invention is an attempt to avoid the problem associated with closed caption text obstructing a portion of the video displayed on a television screen. However, while there is disclosed use of an auxiliary screen, the computer which drives the auxiliary screen is tasked with extracting the closed caption portion from the television signal, processing the video signal portion, and sending the processed video signal to the television display. The auxiliary screen is placed near the television display. However, one problem with this arrangement is that the closed caption extractor does not operate independently from, or autonomously with respect to, the television.

U.S. Pat. No. 6,505,153 to Van Thong, et al. discloses a five-step process for producing closed captions for a television program, subtitles for a movie or other uses for time-aligned transcripts. An operator transcribes the audio track while listening to the recorded material. The system helps him/her to work efficiently and produce precisely aligned captions. The first step consists of identifying the portions of the input audio that contain spoken text. Only the spoken parts are further processed. The other parts may be used to generate non-spoken captions. The second step controls the rate of speech depending on how fast the operator types. While the operator types, the third module records the time the words were typed in. This provides a rough time alignment for the transcribed text. Then the fourth module realigns precisely the transcribed text on the audio track. A final module segments the transcribed text into captions, based on acoustic clues and natural language constraints.

### SUMMARY OF THE INVENTION

In an exemplary embodiment of the present invention, there is disclosed apparatus and method for showing images and text separately and simultaneously on a common display comprising:
a first display having a first screen for showing TV images; and
a second display having a second screen for showing text located adjacent to said first display;
wherein said first display is a flat high resolution LCD or plasma TV showing images free of interwoven text, and said second display is only text associated with the TV images being displayed on the first screen.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1, shows a prior art high resolution wide LCD or plasma TV screen display where text or words of a person or people on the TV screen are displayed overlaying or interwoven with the picture at the bottom of the screen; and

FIG. 2 shows a LCD or plasma TV screen display where a picture without interwoven text is displayed on the main high resolution screen and the text is displayed on a second smaller low resolution low cost TV screen which displays text as white letters on a dark background and which is located below the screen of the main TV where the main TV screen and the smaller low cost TV screen can be located behind a common glass or clear plastic sheet in accordance with the principles of the invention.

### DESCRIPTION OF THE PREFERRED EMBODIMENT

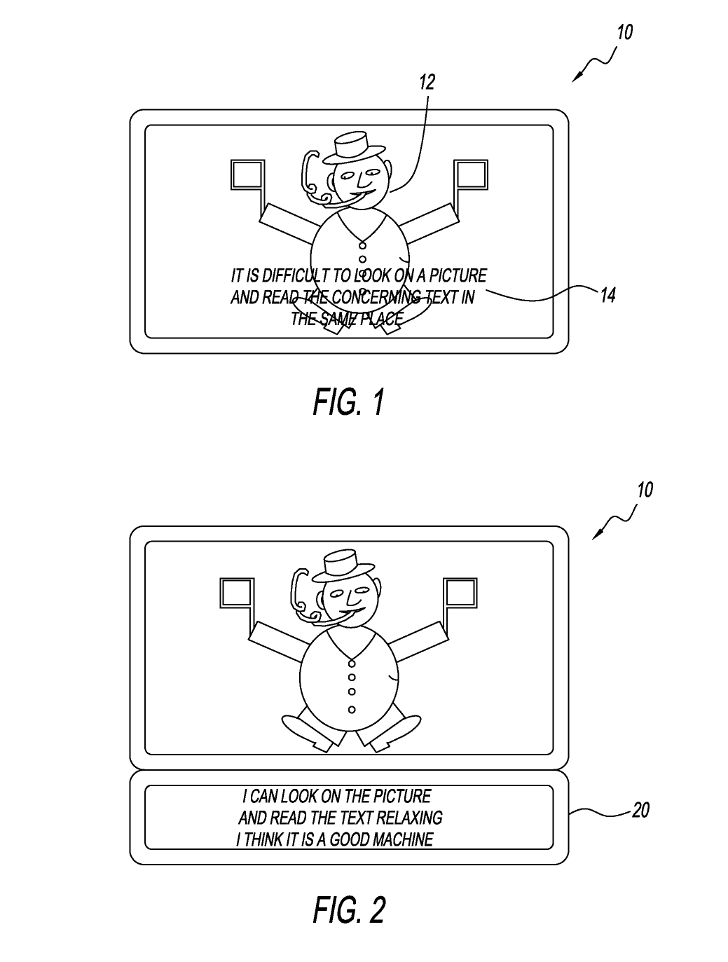

Referring to FIG. 1, there is shown a prior art high resolution LCD or plasma TV screen display where text of a person or people on the TV screen are displayed overlaying or interwoven with the picture at the bottom of the screen. In FIG. 1, the wide LCD or plasma TV screen 10 is showing a motion picture 12 which may be in a foreign language and, therefore, will normally include a caption or subtitle 14 in English which is over layered or interwoven with the picture. The interwoven words are normally black letters which can be difficult for a viewer to read when the picture on the TV set is a night scene, or portions of the picture on the TV set are present as a dark background. Frequently the text of the spoken words may be in partial sentences or phrases which can vary in length and may be shown on one, two or three lines. Unfortunately, a subsequently appearing line may be displaced either slightly above or below a previous line of text which may result in words and sentences which appear to jump up and down. The jumping words and sentences can create tension in the movie viewer.

Additionally, when the text consists of two or three lines of information, the producer of the movie may reduce the size of the letters and/or shorten the time that the text is displayed on the screen. This is done by the producer to avoid obscuring the picture with text and/or to allow the movie viewer to have more time to look at a clean picture of the movie. However, when this is done the viewer may not be able to read the text because the words are too small, or the viewer does not have enough time to completely read the text and understand what is in fact written. particularly if the viewer is a slow reader or some of the words are difficult to read because the contrast between the words and the background is poor.

Referring to FIG. 2, there is disclosed a LCD or plasma TV display where a picture without interwoven text is displayed on the main high resolution screen and the text is displayed on a second smaller low resolution low cost TV screen which displays the text as white letters on a dark background and which can be located below the screen of the main TV where the main TV screen and the smaller low cost TV screen can be located behind a common glass or clear plastic sheet in accordance with the principles of the invention.

Located below the LCD or plasma TV screen 10 which is showing a motion picture 12 is a narrow low cost TV screen 20 which has a width that is substantially equal to the width of TV screen 10. TV screen 20 can be a black and white TV or it can be a full color TV. The height of TV screen 20 can vary from between 2 inches to 5 inches where the larger height will allow for more lines of text and/or text having larger letters to be displayed. Depending on the size of the full display, the text that is displayed on TV screen 20 should be displayed on a minimum of at least one, two or three lines. While the TV screen 20 is shown as being at the bottom of the full size TV screen 10, it is understood that TV screen 20 can be located along the top of the main TV screen 10 or vertically along a side of the main TV screen 10. When the screen 20 is located along the side of the main TV, the text will be displayed vertically rather than horizontally.

TV screen 20 can be made with the same technology that is used to make the LCD or plasma TV screen or, in another embodiment, the text can be displayed using rows and columns of LED's. In the embodiment where LED's are used to display text, the LED's can be of a single color or of different colors.

The main TV screen and the low cost narrow TV screen or the panel of rows and columns of LED's can be abutted against each other as, for example, the top edge of the low cost TV screen or the panel of LED's can be adjacent to the bottom edge of the main TV display and a single sheet of glass or clear plastic which is in a frame can be placed over the main TV screen and the low cost text display.

In operation, the text display, which can be a TV screen or rows and columns of LED's, operate together with the main picture screen to allow a viewer to watch a full size image without interwoven text and, at the same time read related captions and text that is always full size, clear, easy to read and displayed with a non-changing and contrasting background.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A panoramic flat LCD or Plasma display assembled from two displays, wherein the first display is the main high resolution image display used for displaying high quality moving pictures while the second display is an additional display which has a low height low resolution and is a low cost display, located below the main picture display, said second display used mainly to show the titration text concerning the actors talking in the main picture screen while the second display can be made in an LCD or in a Plasma technique or from LED's of white color on a dark background.

2. A panoramic display of claim 1, wherein the second display is produced from any color LED or from different color LED's

3. A panel display for showing images and text separately and simultaneously on a common display comprising:
a first display having a first screen for showing TV images; and
a second display having a second screen for showing text located adjacent to said first display;
wherein said first display is a flat high resolution LCD or plasma TV showing images free of interwoven text, and said second display is only text associated with the TV images being displayed on the first screen.

4. The panel display of claim 3 wherein the second display is a TV display.

5. The panel display of claim 4 wherein said second display is a black and white TV.

6. The panel display of claim 4 wherein said second display is a TV using LCD display technology.

7. The panel display of claim 4 wherein said second display is a TV using plasma display technology.

8. The panel display of claim 3 wherein said second display is an array of rows and columns of LED's.

9. The panel display of claim 8 wherein said LED's are of a common color.

10. The panel display of claim 8 wherein said LED's are of different colors.

11. The panel display of claim 3 wherein the screen of said second display has a width that is equal to or less than the width of the first display and a height that displays text on a minimum of at least one, two or three lines.

12. The panel display of claim 3 wherein said first and second displays are abutted together and located behind a sheet of transparent material located in a frame.

13. A method for showing images and text separately and simultaneously on a common display comprises:
providing a first display having a first screen for showing TV images; and
providing a second display having a second screen for showing text located adjacent to said first display;
wherein said first display is a flat high resolution LCD or plasma TV showing images free of interwoven text, and said second display is only text associated with the TV images being displayed on the first screen.

14. The panel display of claim 13 wherein the second display is a TV display.

15. The panel display of claim 14 wherein said second display is a black and white TV.

16. The method of claim 14 wherein said second display is a TV using LCD display technology.

17. The method of claim 14 wherein said second display is a TV using plasma display technology.

18. The method of claim 13 wherein said second display is an array of rows and columns of LED's.

19. The method of claim 18 wherein said LED's are of a common color.

20. The method of claim 18 wherein said LED's are of different colors.
